(19) United States
(12) Patent Application Publication
(10) Pub. No.: US 2014/0282165 A1
(43) Pub. Date: Sep. 18, 2014

(54) METHOD FOR EXECUTING A PLURALITY OF OBJECT AND RELATED DATA PROCESSING APPARATUS

(71) Applicants: DARFON ELECTRONICS CORP., Taoyuan (TW); DARFON ELECTRONICS (SUZHOU) CO., LTD., Suzhou (CN)

(72) Inventor: Chen-Sheng Tu, Taoyuan (TW)

(73) Assignees: DARFON ELECTRONICS CORP., Taoyuan (TW); DARFON ELECTRONICS (SUZHOU) CO., LTD., Suzhou (CN)

(21) Appl. No.: 14/207,652

(22) Filed: Mar. 13, 2014

(30) Foreign Application Priority Data
Mar. 13, 2013 (TW) 102108848

(51) Int. Cl. G06F 3/0481; G06F 3/033; G06F 3/0486; G06F 3/0484

(52) U.S. Cl. CPC G06F 3/04817; G06F 3/04842; G06F 3/033; G06F 3/0486
USPC 715/769; 715/835

(57) ABSTRACT

A method for executing a plurality of object is disclosed. The method includes establishing a group icon on a screen, assigning a plurality of shortcut links to the group icon by the pointing device, and triggering the group icon to simultaneously start execution of the plurality of objects.

### BACKGROUND OF THE INVENTION

1. Field of the Invention

The present invention relates to a method for executing a plurality of object and a data processing apparatus, and more specifically, to the object executing method for executing a plurality of objects corresponding to shortcut links in a group icon at a time and a related data processing apparatus.

2. Description of the Prior Art

Graphical User Interface (GUI) is a user interface displayed with graphic icons. In contrast to Command Line Interface (CLI) utilized in computer industry earlier, the GUI is more acceptable visually and more facilitated for a user.

As the GUI is widely developed, the GUI is significantly improved in appearance, function and efficiency. The application of the GUI is not limited in a personal computer. The GUI is also widely utilized in portable electronic devices, such as a personal digital assistant (PDA), a handheld computer and a mobile phone.

The GUI includes a plurality of shortcut links. Each of the shortcut links corresponds to an application program, and the shortcut links are arranged in array alignment on the desktop of the GUI. A user can trigger the application program by assigning the corresponding shortcut link so as to execute the application program rapidly.

However, the use must click the shortcut links one by one for executing the individual application programs as utilizing a conventional GUI. In other words, the click times of assigning the shortcut links to execute the corresponding application programs must be increased with increasing application programs to be executed, resulting in inconvenient operation.

### SUMMARY OF THE INVENTION

The present invention is to provide a method for executing a plurality of objects corresponding to shortcut links in a group icon at a time and a related data processing apparatus, to solve the above drawbacks.

According to the disclosure, the method for executing the plurality of objects includes the steps of establishing a group icon on a screen, assigning a plurality of shortcut links to the group icon, wherein each of the plurality of shortcut links corresponding to one of the plurality of objects, and triggering the group icon to simultaneously start execution of the plurality of objects.

According to the disclosure, the method for executing the plurality of objects further includes displaying a symbol on the screen accompanying with the group icon after assigning the plurality of shortcut links to the group icon, wherein the symbol indicates a number of the plurality of shortcut links assigned to the group icon.

According to the disclosure, the method for executing the plurality of object further includes displaying a plurality of windows corresponding to the plurality of objects simultaneously on the screen without overlapping after starting the execution of the plurality of objects.

According to the disclosure, the shortcut link is selected from the group consisting of a program link, a folder link, and a document link.

According to the disclosure, assigning the plurality of shortcut links to the group icon is accomplished by using a pointing device to first drag the plurality of shortcut links and then drop the plurality of shortcut links on the group icon.

According to the disclosure, assigning the plurality of shortcut links to the group icon is accomplished by using the pointing device to copy the plurality of shortcut links to the group icon.

According to the disclosure, triggering the group icon is by double clicking the group icon through the pointing device.

According to the disclosure, establishing the group icon includes popping up a group icon menu through the pointing device, wherein the pointing device controls a cursor movement on the screen, and selecting a group icon establishing command from the group icon menu by the pointing device to establish the group icon at a position of where the cursor located.

According to the disclosure, the method for executing the plurality of objects includes popping up a group icon menu through the pointing device, wherein the pointing device controls a cursor movement on the screen, and selecting a group icon expanding command from the group icon menu by the pointing device to expand the group icon into a group window.

According to the disclosure, the method for executing the plurality of objects includes selecting one of the plurality of shortcut links in the group window and dragging the selected shortcut link out of the group window by the pointing device, so that the selected shortcut link is removed from the group icon.

According to the disclosure, the data processing apparatus is for executing a plurality of objects, the data processing apparatus includes a pointing device, a processor and a screen. The pointing device is for establishing a group icon and for assigning a plurality of shortcut links to the group icon. The processor is for simultaneously starting execution of the plurality of objects corresponding to the plurality of shortcut links as the group icon is triggered. The screen is for displaying the group icon and the plurality of shortcut links.

The method for executing a plurality of objects of the present invention can include establishing different group icons, such as a work group icon, a game group icon or a shopping group icon. The execution of the objects corresponding to the shortcut links in the group icon can start simultaneously as the group icon is triggered. It is not necessary to assign the shortcut links one by one to execute the corresponding objects or application programs, so as to significantly facilitate the operation.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of a data processing apparatus according to a first embodiment of the present invention.

FIG. 2 is a flow chart of a method for executing a plurality of objects according to the first embodiment of the present invention.

FIG. 3A and FIG. 3B are diagrams of a desktop before and after establishing a group icon by a pointing device according to the first embodiment of the present invention.

FIG. 4A to FIG. 4C are diagrams of the desktop when assigning a plurality of shortcut links to the group icon in different stages according to the first embodiment of the present invention.

FIG. 5 is a diagram of the desktop when the group icon is triggered according to the first embodiment of the present invention.

FIG. 6 is a diagram of the desktop when a window of an object corresponding to the shortcut link is executed.

FIG. 7A and 7B are diagrams of the desktop before and after expanding the group icon into a group window according to the first embodiment of the present invention.

FIG. 8 is a diagram of the desktop as removing the shortcut link out of the group window according to the first embodiment of the present invention.

FIG. 9 is a flow chart of a method for executing a plurality of objects according to a second embodiment of the present invention.

FIG. 10 is a diagram of a group icon on a desktop according to the second embodiment of the present invention.

### DETAILED DESCRIPTION

Please refer to FIG. 1 to FIG. 6. FIG. 1 is a functional block diagram of a data processing apparatus 1 according to a first embodiment of the present invention. FIG. 2 is a flow chart of method for executing a plurality of objects according to the first embodiment of the present invention. FIG. 3A and FIG. 3B are diagrams of a desktop 50 before and after establishing a group icon 40 by a pointing device 11 according to the first embodiment of the present invention. FIG. 4A to FIG. 4C are diagrams of the desktop 50 when assigning a plurality of shortcut links 31˜36 to the group icon 40 in different stages according to the first embodiment of the present invention. FIG. 5 is a diagram of the desktop 50 when the group icon 40 is triggered according to the first embodiment of the present invention. FIG. 6 is a diagram of the desktop 50 when a window 53 of an object corresponding to the shortcut link is executed according to the first embodiment of the present invention. The data processing apparatus 1 can be a personal computer, a personal digital assistant, a handheld computer or a mobile phone. The data processing apparatus 1 includes the pointing device 11, a processor 12 and a screen 13. The pointing device 11 can control a cursor movement on the screen 13 for inputting commands to the processor 12, and the pointing device 11 can be a mouse or a touch panel. The desktop 50 is displayed by the screen 13 and includes a plurality of shortcut links, and each shortcut link is corresponding to one object. The number of the plurality of shortcut links depends on the practical requirements. The shortcut links 31˜39 are illustrated in figures for the following instruction.

The object executing method is implemented in the data processing apparatus 1 and includes the following steps.

First, in step 21, a user can click a right button of the pointing device 11 for popping up a group icon menu, and then select a group icon establishing command from the group icon menu. The processor 12 then establishes a group icon 40 in a position of where the cursor located on the desktop 50 according to the command, as shown in FIG. 3A and FIG. 3B. The user can assign the group icon 40 to rename the group icon 40.

And then, in step 22, the user can assign the shortcut links 31˜39 to the group icon 40 by the pointing device 11, as shown in FIG. 4A. The shortcut links 31˜39 can be program links, folder links or document links. As shown in FIG. 4B, the shortcut links 31˜36 can be assigned and dragged by clicking the left button of the pointing device 11. When the six assigned shortcut links 31˜36 are dragged and overlap the group icon 40 to change the color, the left button of the pointing device 11 can be released so as to drop the shortcut links 31˜36 on the group icon 40, so that the six shortcut link 31˜36 are moved from the desktop 50 to the group icon 40. The shortcut links 37˜39 are not added in the group icon 40 and still remain on the desktop 50, as shown in FIG. 4C. The assigned shortcut links 31˜36 can be copied to the group icon 40, and the shortcut links 31˜36 will appear on both the desktop 50 and the group icon 40.

And then, in step 23, the user can move the cursor to the group icon 40 and double click the left button of the pointing device 11 for triggering the group icon 40, as shown in FIG. 5, and the execution of the objects or application programs corresponding to the shortcut links 31˜36 can start simultaneously, as shown in FIG. 6. The objects corresponding to the shortcut 37˜39 are not executed though. After the objects are executed, the screen 13 displays the windows corresponding to the objects one by one. The topmost window 53 of the windows is illustrated in FIG. 6. Besides, the windows corresponding to the objects can be simultaneously displayed on the screen 13 without overlapping.

Please refer to FIG. 7A and 7B. FIG. 7A and 7B are diagrams of the desktop 50 before and after expanding the group icon 40 into a group window 41 according to the first embodiment of the present invention. The user can move the cursor on the group icon 40 and clicks the right button of the pointing device 11 to pop up the group icon menu, as shown in FIG. 7A. When the user selects a group icon expanding command from the group icon menu, the group icon 40 is expanded into a group window 41, so that the user can know which shortcut links are included in the group icon 40 by the group window 41.

Please refer to FIG. 8. FIG. 8 is a diagram of the desktop 50 as removing the shortcut link 34 out of the group window 41 according to the first embodiment of the present invention. For removing the shortcut link 34 out of the group window 41, the user can select the shortcut link 34 in the group window 41 and drag the shortcut link 34 out of the group window 41, and the shortcut links 31˜33 and 35˜36 remain in the group icon 40 . And then, if the group icon 40 is triggered, only the objects corresponding to shortcut links 31˜33 and 35˜36 are executed.

Please refer to FIG. 1, FIG. 9 and FIG. 10. FIG. 9 is a flow chart of a method for executing a plurality of objects according to a second embodiment of the present invention. FIG. 10 is a diagram of the group icon 40 on the desktop 50 according to the second embodiment of the present invention. A difference between the second embodiment and the first embodiment is that the second embodiment further includes a step 24 in addition. The steps 21˜23 of the second embodiment is the same as the steps 21˜23 in the first embodiment and are not reiterated. According to the second embodiment, the processor 12 controls the screen 13 to display a symbol accompanying with the group icon 40, and the symbol indicates a number of the plurality of shortcut links assigned to the group icon 40 of the desktop 50. For example, the group icon 40 includes shortcut links 31˜39, and the symbol indicating a number “9” is displayed on a central area of the group icon 40, as shown in FIG. 10. As removing the shortcut link 31 from the group icon 40, the shortcut links 32˜39 remain and a number “8” is shown on the central area of the group icon 40.

In contrast of the prior art, the method for executing a plurality of objects of the present invention includes establishing different group icons, such as a work group icon, a game group icon or a shopping group icon. The execution of the objects corresponding to the shortcut links in the group icon can start simultaneously as the group icon is triggered. It is not necessary to assign the shortcut links one by one to execute the corresponding objects or application programs, so as to significantly facilitate the operation.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for executing a plurality of objects, the method comprising the steps of:
establishing a group icon on a screen;
assigning a plurality of shortcut links to the group icon, each of the plurality of shortcut links corresponding to one of the plurality of objects; and
triggering the group icon to simultaneously start execution of the plurality of objects.

2. The method for executing the plurality of objects according to claim 1, further comprising: displaying a symbol on the screen accompanying with the group icon after assigning the plurality of shortcut links to the group icon, wherein the symbol indicates a number of the plurality of shortcut links assigned to the group icon.

3. The method for executing the plurality of object according to claim 1, further comprising: displaying a plurality of windows corresponding to the plurality of objects simultaneously on the screen without overlapping after starting the execution of the plurality of objects.

4. The method for executing the plurality of object according to claim 1, wherein the shortcut link is selected from the group consisting of a program link, a folder link, and a document link.

5. A method for executing the plurality of object according to claim 1, wherein assigning the plurality of shortcut links to the group icon is accomplished by using a pointing device to first drag the plurality of shortcut links and then drop the plurality of shortcut links on the group icon.

6. The method for executing the plurality of object according to claim 1, wherein assigning the plurality of shortcut links to the group icon is accomplished by using a pointing device to copy the plurality of shortcut links to the group icon.

7. The method for executing the plurality of object according to claim 1, wherein triggering the group icon is by double clicking the group icon through a pointing device.

8. The method for executing the plurality of object according to claim 7, wherein establishing the group icon comprises:
popping up a group icon menu through a pointing device, the pointing device controlling a cursor movement on the screen; and
selecting a group icon establishing command from the group icon menu by the pointing device to establish the group icon at a position of where the cursor located.

9. The method for executing the plurality of object according to claim 7, further comprising:
popping up a group icon menu through a pointing device, the pointing device controlling a cursor movement on the screen; and
selecting a group icon expanding command from the group icon menu by the pointing device to expand the group icon into a group window.

10. The method for executing the plurality of object according to claim 9, further comprising: selecting one of the plurality of shortcut links in the group window and dragging the selected shortcut link out of the group window by the pointing device, so that the selected shortcut link is removed from the group icon.

11. A data processing apparatus for executing a plurality of objects, the data processing apparatus comprising:
a pointing device for establishing a group icon and for assigning
a plurality of shortcut links to the group icon;
a processor for simultaneously starting execution of the plurality of objects corresponding to the plurality of shortcut links as the group icon is triggered; and
a screen for displaying the group icon and the plurality of shortcut links.

12. The data processing apparatus of claim 11, wherein the screen displays a symbol accompanying with the group icon after the plurality of shortcut links are assigned to the group icon, and the symbol indicates a number of the plurality of shortcut links assigned to the group icon.

13. The data processing apparatus of claim 11, wherein the screen displays a plurality of windows corresponding to the plurality of objects after the execution of the plurality of objects corresponding to the plurality of shortcut links starts, and the plurality of windows are displayed without overlapping.

14. The data processing apparatus of claim 11, wherein the shortcut link is selected from the group consisting of a program link, a folder link or a document link.

15. The data processing apparatus of claim 11, wherein the plurality of shortcut links is dragged and dropped on the group icon by the pointing device.

16. The data processing apparatus of claim 11, wherein the plurality of shortcut links is copied for assigning to the group icon by the pointing device.

17. The data processing apparatus of claim 11, wherein the pointing device is a mouse, and a left button of the pointing device is double clicked for triggering the group icon.

18. The data processing apparatus of claim 17, wherein the pointing device controls a cursor movement on the screen for popping up a group icon menu, the group icon menu comprises a group icon establishing command, and the group icon establishing command is selected for establishing the group icon by the pointing device at a position where the cursor located.

19. The data processing apparatus of claim 17, wherein the pointing device controls a cursor movement on the screen for popping up a group icon menu, the group icon menu comprises a group icon expanding command, and the group icon expanding item is selected by the pointing device for expanding the group icon into a group window.

20. The data processing apparatus of claim 19, wherein one of the plurality of shortcut links in the group window is selected to be dragged out of the group window by the pointing device, so that the selected shortcut link is removed from the group icon.
